(19) United States
(12) Patent Application Publication
(10) Pub. No.: US 2025/0306346 A1
(43) Pub. Date: Oct. 2, 2025

(54) OPTICAL APPARATUS AND IMAGE PICKUP APPARATUS

(71) Applicant: CANON KABUSHIKI KAISHA, Tokyo (JP)

(72) Inventors: Tomoaki YAMANAKA, Tochigi (JP); Fuya MIZUOCHI, Saitama (JP); Shunji IWAMOTO, Tochigi (JP)

(21) Appl. No.: 19/238,755

(22) Filed: Jun. 16, 2025

Related U.S. Application Data
(63) Continuation of application No. PCT/JP2023/039381, filed on Nov. 1, 2023.

(30) Foreign Application Priority Data
Dec. 23, 2022 (JP) 2022-207638

(51) Int. Cl. G02B 15/14

(52) U.S. Cl. CPC G02B 15/144511

(57) ABSTRACT

An optical apparatus includes an optical system consisting of, in order from an object side to an image side, a first lens unit with negative refractive power, a second lens unit with positive refractive power, a third lens unit with negative refractive power, and a fourth lens unit with positive refractive power, a first drive unit configured to move the second lens unit, a second drive unit configured to move the third lens unit. The first and fourth lens units are fixed relative to an image plane during zooming and focusing, the second lens unit moves toward the object side during zooming, and the third lens unit moves toward the image side during focusing. When the control unit controls the first drive unit by feedback control using the information from the first acquiring unit during zooming, the control unit controls the second drive unit by open loop control.

### CROSS-REFERENCE TO RELATED APPLICATIONS

This application is a Continuation of International Patent Application No. PCT/JP2023/039381, filed on Nov. 1, 2023, which claims the benefit of Japanese Patent Application No. 2022-207638, filed on Dec. 23, 2022, both of which are hereby incorporated by reference herein in their entirety.

### BACKGROUND

### Technical Field

The present disclosure relates to an optical apparatus and an image pickup apparatus.

### Description of Related Art

As a small and lightweight zoom lens, a zoom lens has conventionally been proposed that consists, in order from the object side to the image side, first to fourth lens units with negative, positive, negative, and positive refractive powers, wherein the first and fourth lens units are stationary during zooming and focusing (see Japanese Patent Application Laid-Open No. 2013-218256).

### SUMMARY

An optical apparatus according to one aspect of the disclosure includes an optical system consisting of, in order from an object side to an image side, a first lens unit with negative refractive power, a second lens unit with positive refractive power, a third lens unit with negative refractive power, and a fourth lens unit with positive refractive power, a first drive unit configured to move the second lens unit, a second drive unit configured to move the third lens unit, a first acquiring unit configured to acquire one of information on drive of the first drive unit and information on a position of the second lens unit, and a processor that, upon execution of instructions, is configured to control the first drive unit and the second drive unit. The first lens unit and the fourth lens unit are fixed relative to an image plane during zooming and focusing, the second lens unit moves toward the object side during zooming from a wide-angle end to a telephoto end, and the third lens unit moves toward the image side during focusing from infinity to a close distance. When the control unit controls the first drive unit by feedback control using the information from the first acquiring unit during zooming, the control unit controls the second drive unit by open loop control. An image pickup apparatus having the above optical apparatus also constitutes another aspect of the disclosure.

Further features of various embodiments of the disclosure will become apparent from the following description of embodiments with reference to the attached drawings.

### BRIEF DESCRIPTION OF THE DRAWINGS

FIGS. 1A and 1B are block diagrams of an optical apparatus according to one embodiment of the present disclosure.

FIG. 2 is a sectional view of a zoom lens according to Example 1.

FIGS. 3A and 3B are aberration diagrams of the zoom lens according to Example 1.

FIG. 4 is a sectional view of a zoom lens according to Example 2.

FIGS. 5A and 5B are aberration diagrams of the zoom lens according to Example 2.

FIG. 6 is a sectional view of a zoom lens according to Example 3.

FIGS. 7A and 7B are aberration diagrams of the zoom lens according to Example 3.

FIG. 8 is a sectional view of a zoom lens according to Example 4.

FIGS. 9A and 9B are aberration diagrams of the zoom lens according to Example 4.

FIG. 10 is a sectional view of a zoom lens according to Example 5.

FIGS. 11A and 11B are aberration diagrams of the zoom lens according to Example 5.

FIG. 12 is a schematic diagram of an image pickup apparatus.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of examples according to the present disclosure. Corresponding elements in respective figures will be designated by the same reference numerals, and a duplicate description thereof will be omitted.

In the zoom lens disclosed in Japanese Patent Application Laid-Open No. 2013-218256, the second lens unit is a zoom unit that moves during magnification variation, and the third lens unit is a focus unit that moves during focusing. Usually, the mass of the second lens unit as the zoom unit, is larger than the mass of the third lens unit as the focus unit. In controlling the zoom lens disclosed in Japanese Patent Application Laid-Open No. 2013-218256, for example, if a stepping motor for moving the second lens unit having a larger mass is controlled by open loop control, the stepping motor may step out (lose synchronism). In a case where a high-torque stepping motor is used to suppress stepping out and the drive torque is increased, the power consumption and drive noise increase. Furthermore, in a case where a stepping motor for moving the third lens unit having a smaller mass is controlled by feedback control, power consumption may unnecessarily increase. However, Japanese Patent Application Laid-Open No. 2013-218256 is silent about a method for controlling drive units for moving the second lens unit and the third lens unit.

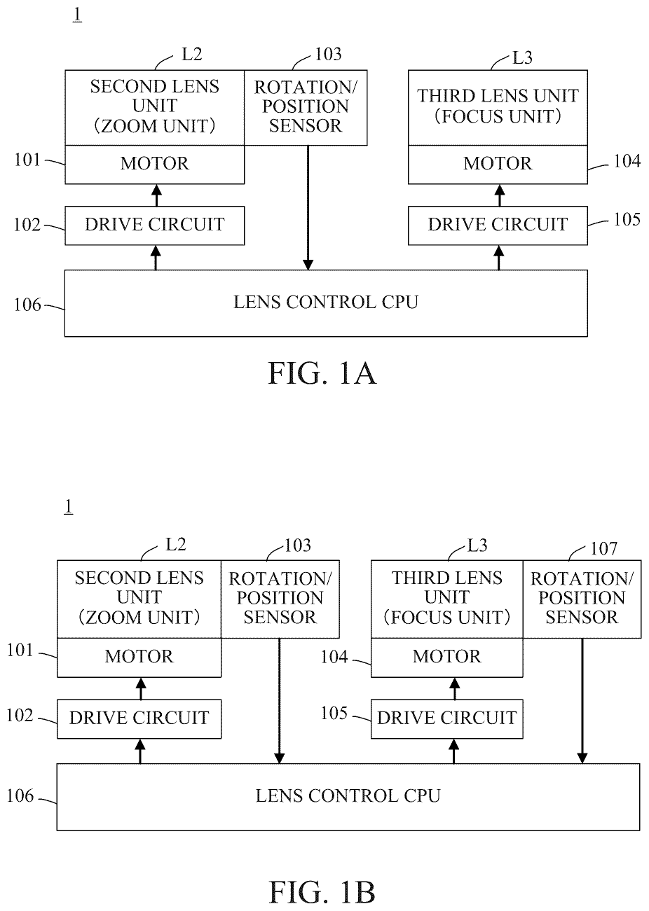

FIG. 1A is a block diagram of an optical apparatus 1 according to one embodiment of the present disclosure. The optical apparatus 1 includes a zoom lens (optical system) L0, a motor (first drive unit) 101, a drive circuit 102, a rotation/position sensor (first acquiring unit) 103, a motor (second drive unit) 104, a drive circuit 105, and a lens control CPU (control unit) 106.

The zoom lens L0 includes a plurality of lens units. The plurality of lens units consists of, in order from the object side to the image side, a first lens unit L1 with negative refractive power (optical power=inverse of focal length), a second lens unit L2 with positive refractive power, a third lens unit L3 with negative refractive power, and a fourth lens unit L4 with positive refractive power. The first lens unit L1 and the fourth lens unit L4 are fixed relative to the image plane during zooming and focusing. The second lens unit L2 serves as a zoom unit that includes three or more lenses and moves to the object side during zooming from the wide-angle end to the telephoto end. The third lens unit L3 serves as a focus unit that includes two or fewer lenses and moves toward the image side during focusing from infinity to a close distance. By moving the third lens unit L3, which has a relatively small lens diameter and a reduced weight, during focusing, the drive mechanism is simple and the size of the zoom lens L0 can be easily reduced. The second lens unit L2 may be fixed relative to the image plane during focusing.

The motor 101 is a stepping motor configured to move the second lens unit L2. The drive circuit 102 drives the motor 101 according to instructions from the lens control CPU 106. The rotation/position sensor 103 acquires information on the driving (rotation) of the motor 101 or information on the position of the second lens unit L2.

The motor 104 includes a stepping motor configured to move the third lens unit L3. The drive circuit 105 drives the motor 104 according to instructions from the lens control CPU 106.

This embodiment uses a stepping motor, which is an example of an electromagnetic motor, as the motors 101 and 104, but is not limited to this example. A voice coil motor, a DC motor, or a piezoelectric motor may be used as the motor 101.

This embodiment uses a motor as a drive unit configured to drive the second lens unit L2 and the third lens unit L3, but is not limited to this example. As long as the second lens unit L2 and the third lens unit L3 can be moved, an actuator other than a motor may be used.

The lens control CPU 106 includes at least one processor that, upon execution of instructions, is configured to control the motors 101 and 104 via the drive circuits 102 and 105. As described above, the second lens unit L2 and the third lens unit L3 are a zoom unit and a focus unit, respectively, and the mass of the second lens unit L2 is larger than the mass of the third lens unit L3. In this embodiment, the lens control CPU 106 controls the motor 101 for moving the second lens unit L2 having a larger mass by feedback control using information from the rotation/position sensor 103. This configuration can suppress step-out of the motor 101. In addition, power consumption and drive noise can be reduced compared to those that occur in a case where a high-torque stepping motor is controlled by open-loop control. Furthermore, the lens control CPU 106 controls the motor 104 for moving the third lens unit L3 having a smaller mass by open-loop control. This configuration can restrain power consumption from becoming excessively large.

The lens control CPU 106 controls the motor 101 by feedback control using information from the rotation/position sensor 103 during zooming. At this time, the lens control CPU 106 controls the motor 104 by open-loop control to correct focus fluctuations caused by the movement of the second lens unit L2.

In addition, as illustrated in FIG. 1B, the optical apparatus 1 may include, in addition to the configuration illustrated in FIG. 1A, a rotation/position sensor (second acquiring unit) 107 configured to acquire information on the drive (rotation) of the motor 104 or information on the position of the third lens unit L3. In this case, the lens control CPU 106 controls the motor 104 by feedback control using information from the rotation/position sensor 107 or by open-loop control.

For example, the lens control CPU 106 may control the motor 104 according to the drive speed (rotation speed) of the motor 104. More specifically, in a case where the drive speed of the motor 104 is greater than a predetermined value, the lens control CPU 106 controls the motor 104 by feedback control using information from the rotation/position sensor 107. In a case where the drive speed of the motor 104 is less than the predetermined value, the lens control CPU 106 controls the motor 104 by open loop control. In a case where the drive speed of the motor 104 is equal to the predetermined value, it is possible to arbitrarily set which control the lens control CPU 106 will perform.

The lens control CPU 106 may control the motor 104 according to a change amount in the drive speed (rotation speed) of the motor 104. More specifically, in a case where a change amount in the drive speed of the motor 104 is greater than a predetermined value, the lens control CPU 106 controls the motor 104 by feedback control using information from the rotation/position sensor 107. Furthermore, in a case where a change amount in the drive speed of the motor 104 is smaller than a predetermined value, the lens control CPU 106 controls the motor 104 by open loop control. In a case where a change amount in the drive speed of the motor 104 is equal to the predetermined value, it is possible to arbitrarily set which control the lens control CPU 106 will perform.

As described above, the lens control CPU 106 can normally restrain power consumption from becoming greater than the necessary amount by controlling the motor 104 by open loop control. On the other hand, in a case where the drive speed or the change amount in the drive speed of the motor 104 increases, the lens control CPU 106 can restrain the motor 104 from stepping out by controlling the motor 104 by feedback control.

The configuration of the zoom lens L0 will now be described.

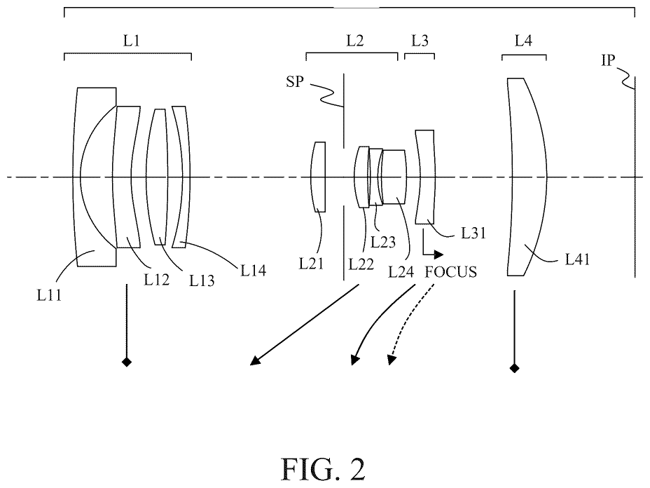

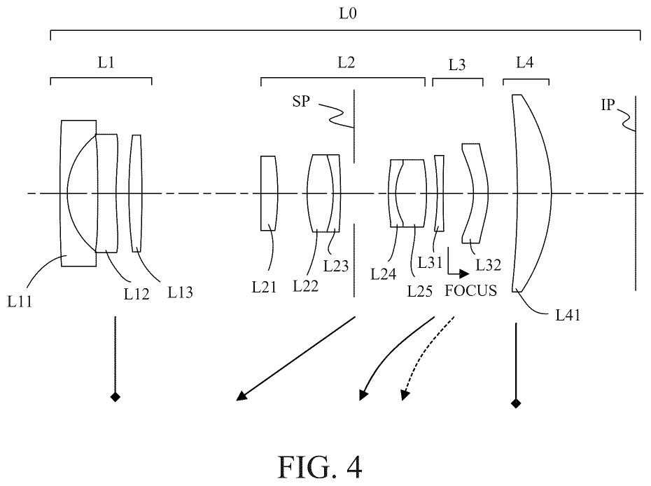

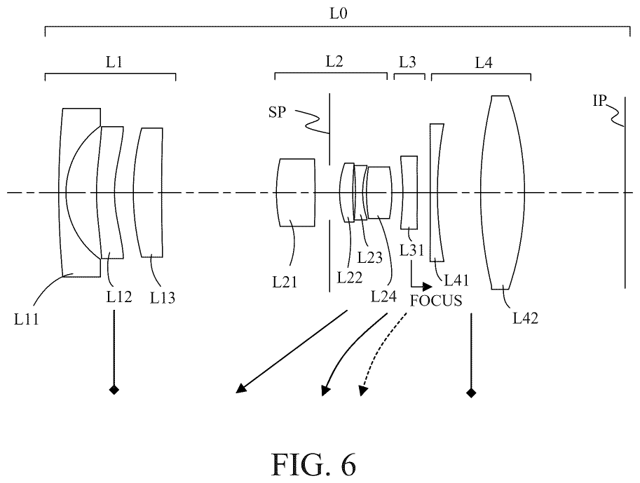

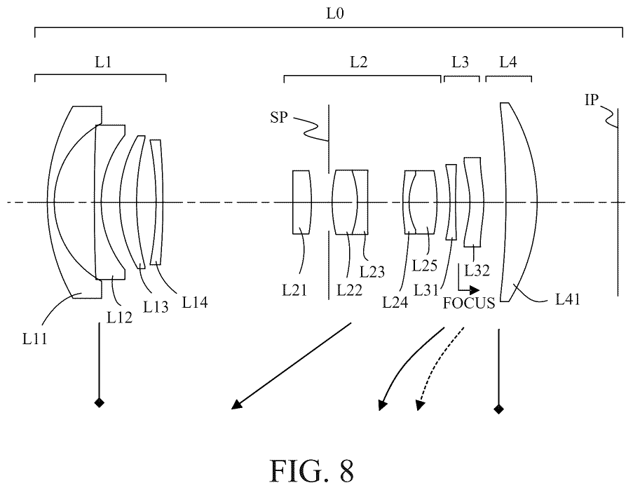

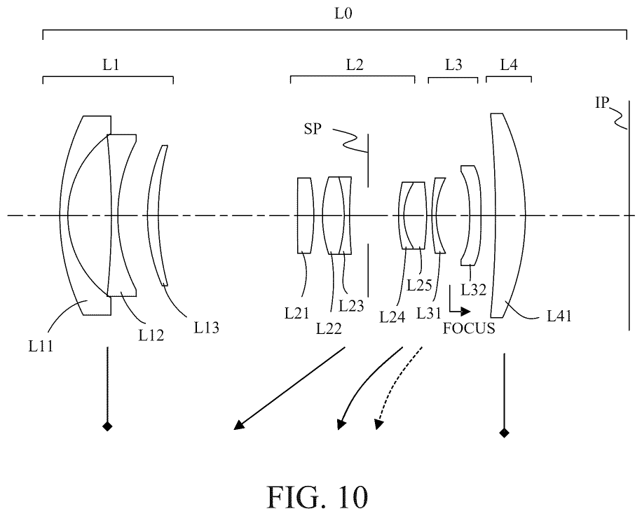

FIGS. 2, 4, 6, 8, and 10 are sectional views of zoom lenses L0 according to Examples 1 to 5 in an in-focus state (on an object) at infinity at a wide-angle end, respectively. The zoom lens L0 according to each example is used in an image pickup apparatus such as a digital still camera, a film-based camera, a digital video camera, a security camera, a broadcasting camera, or an in-vehicle (on-board) camera. The zoom lens L0 according to each example can also be used as a projection optical system for a projection apparatus (projector).

In each sectional view, a left side is an object side (front) and a right side is an image side (rear). The zoom lens L0 according to each example includes a plurality of lens units. In this specification, a lens unit is a group of lenses that move or stand still as a unit during zooming. That is, in the zoom lens L0 according to each example, a distance between adjacent lens units changes during zooming from the wide-angle end to the telephoto end. The lens unit may include one or more lenses. The lens unit may further include an aperture stop.

In each sectional view, Li represents an i-th lens unit (where i is a natural number) of the zoom lens L0, counted from the object side.

SP represents an aperture stop. The aperture stop SP determines (limits) a light beam of the full aperture F-number (Fno). IP represents an image plane. In a case where the zoom lens L0 according to each example is used as an imaging optical system in a digital still camera or video camera, an imaging surface of a solid-state image sensor (photoelectric conversion element) such as a CCD sensor or CMOS sensor is placed on the image plane IP. In a case where the zoom lens L0 according to each example is used as the imaging optical system of a film-based camera, a photosensitive surface equivalent to the film surface is placed on the image plane IP.

An arrow in the optical axis direction indicates a moving direction of the focus unit that moves during focusing from infinity to a close distance (short distance). In addition, a solid arrow written under each lens unit indicates a moving trajectory of each lens unit during zooming from the wide-angle end to the telephoto end in an in-focus state on an object at infinity. A dotted arrow written under a specific lens unit indicates a moving trajectory of the specific lens unit during zooming from the wide-angle end to the telephoto end in an in-focus state on a close object (an object at a close distance).

In the following examples, a wide-angle end and a telephoto end refer to zoom positions when the zooming lens unit is located at both ends of a mechanically movable range on the optical axis.

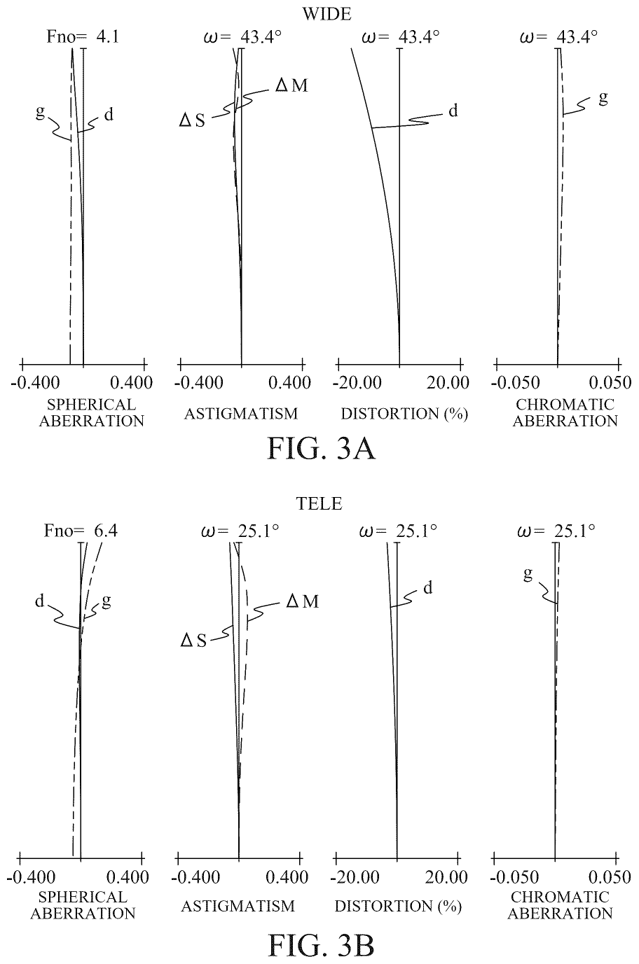

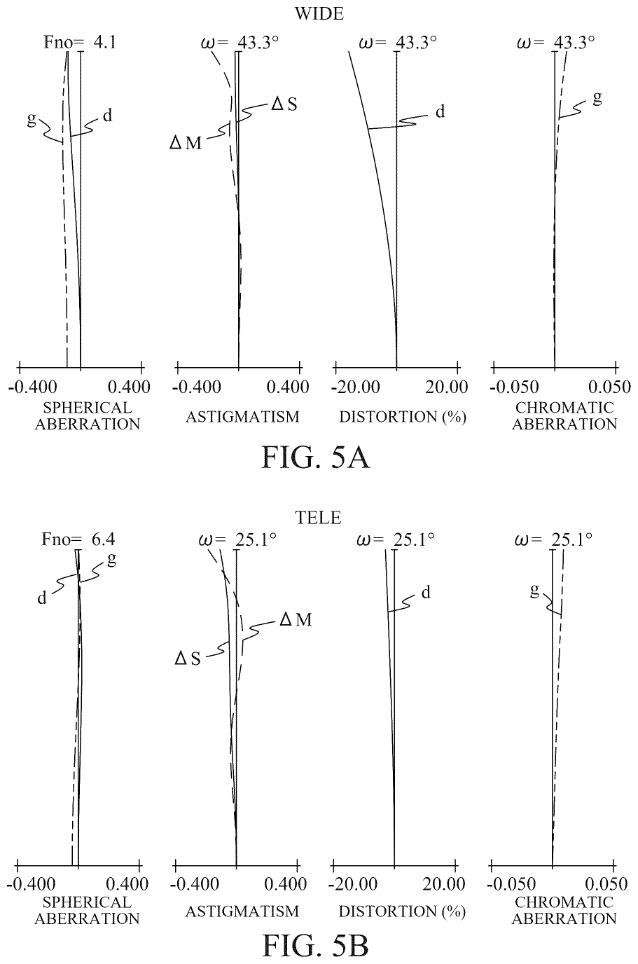

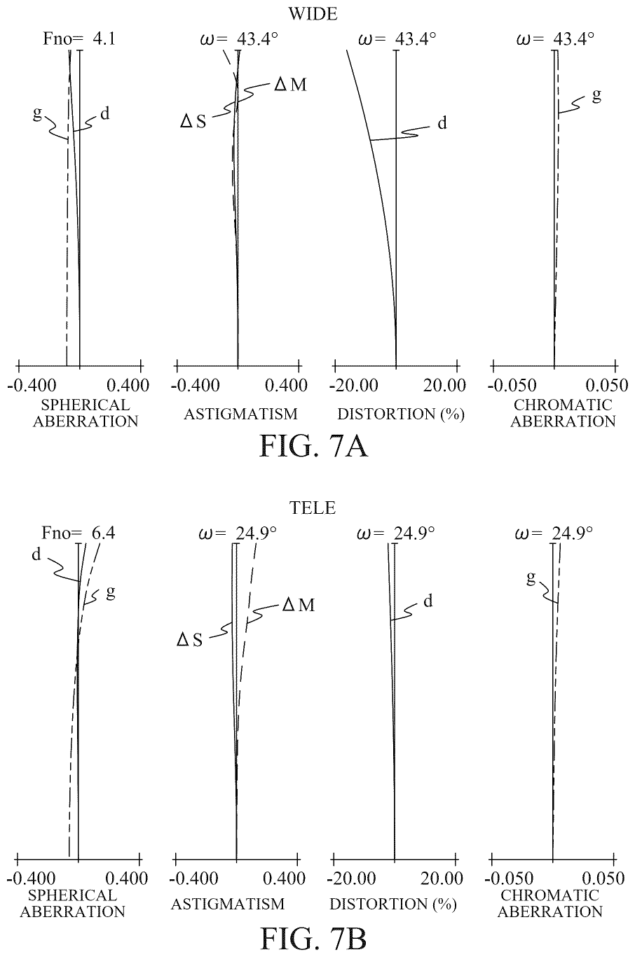

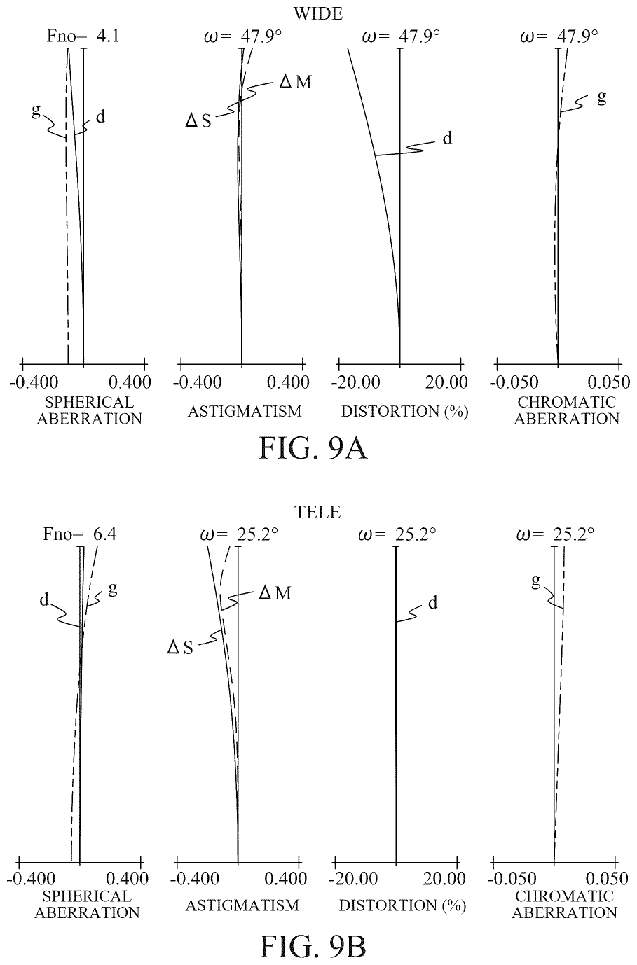

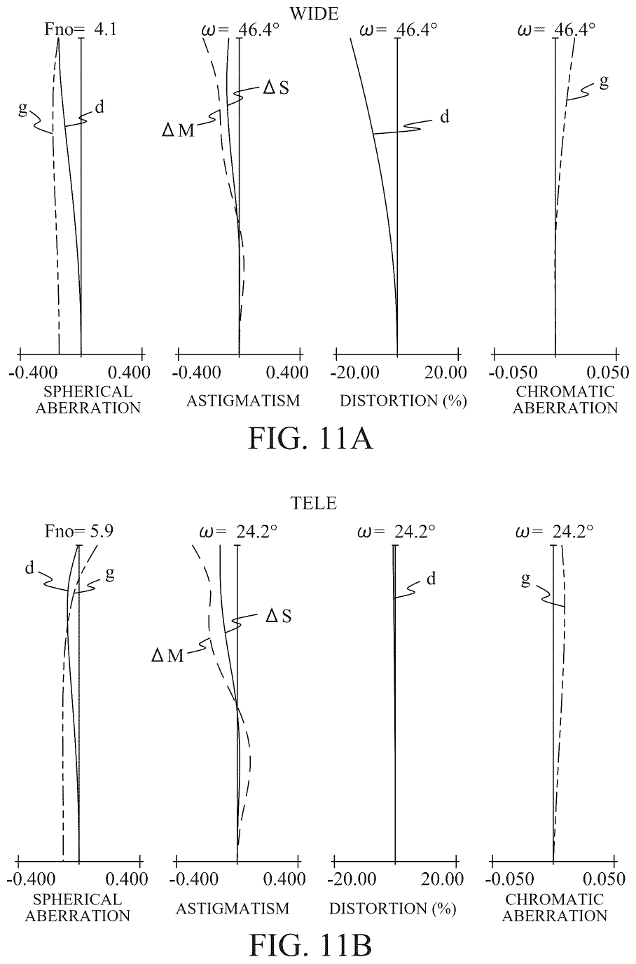

FIGS. 3A, 3B, 5A, 5B, 7A, 7B, 9A, 9B, 11A, and 11B are aberration diagrams of the zoom lenses L0 according to Examples 1 to 5 in an in-focus state at infinity, respectively. FIGS. 3A, 5A, 7A, 9A, and 11A are aberration diagrams at the wide-angle end, while FIGS. 3B, 5B, 7B, 9B, and 11B are aberration diagrams at the telephoto end.

In a spherical aberration diagram, Fno represents an F-number. The spherical aberration diagram illustrates spherical aberration amounts for the d-line (wavelength 587.56 nm) and the g-line (wavelength 435.83 nm). In an astigmatism diagram, ΔS indicates an astigmatism amount on a sagittal image plane for the d-line, and ΔM indicates an astigmatism amount on a meridional image plane for the d-line. A distortion diagram illustrates a distortion amount for the d-line. A chromatic aberration diagram illustrates a chromatic aberration amount for the g-line. ω is an imaging half angle of view (°) (angle of view in paraxial calculation), and indicates an angle of view based on a ray tracing value.

Next follows a description of the characteristic configuration of the zoom lens L0 according to each example.

The zoom lens L0 according to each example has a plurality of lens units. The plurality of lens units consist of, in order from the object side to the image side, a first lens unit L1 with negative refractive power, a second lens unit L2 with positive refractive power, a third lens unit L3 with negative refractive power, and a fourth lens unit L4 with positive refractive power. In the zoom lens L0 according to each example, a distance between adjacent lens units changes during zooming from the wide-angle end to the telephoto end. During zooming from the wide-angle end to the telephoto end, the first lens unit L1 and the fourth lens unit L4 are fixed relative to the image plane IP. The first lens unit L1, which is located closest to the object and has the largest lens diameter, and the fourth lens unit L4, which is located closest to the image plane, are fixed relative to the image plane IP, and only the second lens unit L2 and the third lens unit L3, which have relatively small lens diameters, move during zooming. This configuration can easily provide a zoom lens L0 that achieves high-speed zoom operation.

In the zoom lens L0 according to each example, the first lens unit L1 is fixed relative to the image plane IP during focusing from infinity to a close distance. By fixing the first lens unit L1, which is located closest to the object and has the largest lens diameter, during focusing, a drive mechanism can be simple and the size of the zoom lens L0 can be easily reduced.

In the zoom lens L0 according to each example, during zooming from the wide-angle end to the telephoto end, the third lens unit L3 moves toward the object side. Moving the third lens unit L3 to a position away from the image plane IP at the telephoto end can easily reduce the lens diameter of the third lens unit L3, and finally the size and weight of the zoom lens L0.

The zoom lens L0 according to each example satisfies the following inequalities (1) and (2):

$$0.7 < - f 1 / f 2 < 1.5 \qquad ( 1 )$$

$$0.1 < - f 2 / f 3 < 0.9 \qquad ( 2 )$$

where f1 is a focal length of the first lens unit L1, f2 is a focal length of the second lens unit L2, and f3 is a focal length of the third lens unit L3.

Inequality (1) defines a relationship between the focal length f1 of the first lens unit L1 and the focal length f2 of the second lens unit L2. In a case where −f1/f2 becomes higher than the upper limit of inequality (1), it becomes difficult to suppress the front lens diameter, and the size of the zoom lens L0 increases. In a case where −f1/f2 becomes lower than the lower limit of inequality (1), it becomes difficult to correct distortion at the wide-angle end.

Inequality (2) defines a relationship between the focal length f2 of the second lens unit L2 and the focal length f3 of the third lens unit L3. In a case where −f2/f3 becomes higher than the upper limit of inequality (2), it becomes difficult to correct the Petzval sum, the curvature of field increases, and it becomes difficult to achieve high image quality. In a case where −f2/f3 becomes lower than the lower limit of inequality (2), it becomes difficult to correct aberrations occurring in the second lens unit L2, and in particular, it becomes difficult to correct zoom fluctuations in spherical aberration and astigmatism, and it becomes difficult to achieve high image quality.

Inequalities (1) and (2) may be replaced with inequalities (1a) and (2a) below:

$$0.85 < - f 1 / f 2 < 1.38 \qquad ( 1 a )$$

$$0.17 < - f 2 / f 3 < 0.82 \qquad ( 2 a )$$

Inequalities (1) and (2) may be replaced with inequalities (1b) and (2b) below:

$$0.95 < - f 1 / f 2 < 1.32 \qquad ( 1 b )$$

$$0.2 < - f 2 / f 3 < 0.78 \qquad ( 2 b )$$

Next follows a description of the configurations that may be satisfied by the zoom lens L0 according to each example.

In the zoom lens L0 according to each example, the first lens unit L1 may include two negative lenses and one positive lens. This configuration can easily and satisfactorily correct lateral chromatic aberration and coma at the wide-angle end.

In the zoom lens L0 according to each example, the first lens unit L1 may include a negative meniscus lens with a convex surface facing the object side, which is disposed closest to the object in the first lens unit L1. This configuration can easily and satisfactorily correct distortion at the wide-angle end.

In the zoom lens L0 according to each example, the second lens unit L2 may include a positive lens disposed closest to the object in the second lens unit L2. This configuration can easily reduce the overall length.

In the zoom lens L0 according to each example, the second lens unit L2 may include four or five lenses. This configuration can easily suppress fluctuations of spherical aberration, longitudinal chromatic aberration, and lateral chromatic aberration during magnification variation.

In the zoom lens L0 according to each example, the second lens unit L2 may include three positive lenses and one biconcave lens. Distributing the refractive powers by placing three positive lenses can easily correct various aberrations, particularly suppress zoom fluctuations in astigmatism and spherical aberration. Distributing one biconcave lens can easily suppress zoom fluctuations of longitudinal chromatic aberration, spherical aberration, astigmatism, and lateral chromatic aberration.

In the zoom lens L0 according to each example, the second lens unit L2 may include three positive lenses, one negative lens (first negative lens) with a concave surface facing the object side, and one negative lens (second negative lens) with a concave surface facing the image side, which is disposed on the image side of the first negative lens. Distributing the refractive power by placing the three positive lenses can easily correct various aberrations, particularly the suppression of zoom fluctuations in astigmatism and spherical aberration. Distributing one negative lens with a concave surface facing the object side can easily suppress zoom fluctuations in spherical aberration and longitudinal chromatic aberration. Placing one negative lens with a concave surface facing the image side on the image side of the negative lens with a concave surface facing the object side can easily suppress zoom fluctuations in astigmatism and lateral chromatic aberration.

In the zoom lens L0 according to each example, the second lens unit L2 may include an aperture stop SP, and the second lens unit L2 and the aperture stop SP may move together during zooming from the wide-angle end to the telephoto end. Moving the aperture stop SP together with the second lens unit L2 that moves during zooming can easily optimize the balance of aberration correction before and after the aperture stop SP, and achieve high image quality.

In the zoom lens L0 according to each example, the third lens unit L3 may include a lens with negative refractive power that is disposed closest to the object in the third lens unit L3. Placing a negative lens closest to the object in the third lens unit L3 can easily reduce the overall length, and finally the size and weight of the zoom lens L0.

In the zoom lens L0 according to each example, the third lens unit L3 may include a lens having an aspherical lens surface with negative refractive power stronger at the peripheral part than at the central part (an absolute value of refractive power of the negative lens is larger at a peripheral part than at a central part). Placing a lens having an aspherical lens surface in the third lens unit L3 with negative refractive power stronger at the peripheral part can easily correct various aberrations, particularly distortion at the wide-angle end, and achieve high image quality. The third lens unit L3 may consist of two lenses spaced apart from each other.

In the zoom lens L0 according to each example, the fourth lens unit L4 may consist of two or fewer lenses. Since the fourth lens unit L4 is close to the image plane IP, as the number of lenses in the fourth lens unit L4 increases, flare and ghosting are more likely to occur, and it becomes difficult to achieve high image quality.

Next follows a description of conditions that may be satisfied by the zoom lens L0 according to each example. The zoom lens L0 according to each example may satisfy one or more of the following inequalities (3) and (4):

$$0.5 < M 2 / fw < 2. \qquad ( 3 )$$

$$0.4 < M 3 / fw < 1.6 \qquad ( 4 )$$

Here, fw is a focal length of the zoom lens L0 in the in-focus state at infinity at the wide-angle end. M2 is a moving amount of the second lens unit L2 during zooming from the wide-angle end to the telephoto end. A moving amount has a positive value in a case where it moves toward the object side during zooming from the wide-angle end to the telephoto end. M3 is a moving amount of the third lens unit L3 during zooming from the wide-angle end to the telephoto end. A moving amount has a positive value in a case where it moves toward the object side during zooming from the wide-angle end to the telephoto end.

Inequality (3) defines a relationship between the moving amount M2 of the second lens unit L2 during zooming and the focal length fw of the zoom lens L0 at the wide-angle end. In a case where M2/fw becomes higher than the upper limit of inequality (3), the size of the zoom lens L0 increases. In a case where M2/fw becomes lower than the lower limit of inequality (3), it becomes difficult to achieve high magnification variation of the zoom lens L0.

Inequality (4) defines a relationship between the moving amount M3 during zooming using the third lens unit L3 and the focal length fw of the zoom lens L0 at the wide-angle end. In a case where M3/fw becomes higher than the upper limit of inequality (4), the size of the zoom lens L0 increases. In a case where M3/fw becomes lower than the lower limit of inequality (4), it becomes difficult to achieve high magnification variation of the zoom lens L0.

Inequalities (3) and (4) may be replaced with inequalities (3a) and (4a) below:

$$0.66 < M 2 / fw < 1.7 \qquad ( 3 a )$$

$$0.52 < M 3 / fw < 1.31 \qquad ( 4 a )$$

Inequalities (3) and (4) may be replaced with inequalities (3b) and (4b) below:

$$0.74 < M 2 / fw < 1.55 \qquad ( 3 b )$$

$$0.58 < M 3 / fw < 1.17 \qquad ( 4 b )$$

Next follows a detailed description of the zoom lens L0 according to each example.

The zoom lens L0 according to Example 1 includes a plurality of lens units that consist of, in order from the object side to the image side, a first lens unit L1 with negative refractive power, a second lens unit L2 with positive refractive power, a third lens unit L3 with negative refractive power, and a fourth lens unit L4 with positive refractive power. During zooming from the wide-angle end to the telephoto end, the first lens unit L1 and the fourth lens unit L4 are fixed relative to the image plane IP. During zooming from the wide-angle end to the telephoto end, the second lens unit L2 and the third lens unit L3 move toward the object side. During focusing from infinity to a close distance, the third lens unit L3 moves toward the image side. The first lens unit L1 includes, in order from the object side, a negative meniscus lens L11 with a convex surface facing the object side, a negative meniscus-shaped aspheric lens L12 with a convex surface facing the object side, a biconvex lens L13, and a negative meniscus lens L14 with a convex surface facing the image side. The second lens unit L2 includes, in order from the object side, a biconvex lens L21, an aperture stop SP, a positive meniscus lens L22 with a convex surface facing the object side, a biconcave lens L23, and a biconvex lens L24. The third lens unit L3 includes a negative meniscus-shaped aspheric lens L31 with a convex surface facing the image side. The lens L31 has aspheric surfaces on both sides, with the object side surface being aspheric with positive refractive power stronger at the peripheral part than at the central part, and the image side surface being aspheric with negative refractive power stronger at the peripheral part than at the central part (i.e., an absolute value of refractive power of the negative lens is larger at a peripheral part than at a central part). The fourth lens unit L4 includes a positive meniscus lens L41 with a convex surface facing the image side.

The zoom lens L0 according to Example 2 includes a plurality of lens units that consist of, in order from the object side to the image side, the first lens unit L1 with negative refractive power, the second lens unit L2 with positive refractive power, the third lens unit L3 with negative refractive power, and the fourth lens unit L4 with positive refractive power. During zooming from the wide-angle end to the telephoto end, the first lens unit L1 and the fourth lens unit L4 are fixed relative to the image plane IP. During zooming from the wide-angle end to the telephoto end, the second lens unit L2 and the third lens unit L3 move toward the object side. During focusing from infinity to a close distance, the third lens unit L3 moves toward the image side. The first lens unit L1 includes, in order from the object side, a negative meniscus lens L1l with a convex surface facing the object side, a biconcave aspheric lens L12, and a biconvex lens L13. The second lens unit L2 includes, in order from the object side, a positive meniscus lens L21 with a convex surface facing the image side, a biconvex lens L22, a negative meniscus lens L23 with a concave surface facing the object side, an aperture stop SP, a negative meniscus lens L24 with a concave surface facing the image side, and a biconvex lens L25. The lens L22 and the lens L23 form a cemented lens. The lens L24 and the lens L25 form a cemented lens. The third lens unit L3 includes, in order from the object side, a biconcave lens L31 and a negative meniscus-shaped aspheric lens L32 with its concave surface facing the object side. The lens L32 has aspheric surfaces on both sides, with the object side surface being aspheric with positive refractive power stronger at the peripheral part than at the central part, and the image side surface being aspheric with negative refractive power stronger at the peripheral part than at the central part (i.e., an absolute value of refractive power of the negative lens is larger at a peripheral part than at a central part). The fourth lens unit L4 includes a positive meniscus lens L41 with a convex surface facing the image side.

The zoom lens L0 according to Example 3 includes a plurality of lens units that consist of, in order from the object side to the image side, a first lens unit L1 with negative refractive power, a second lens unit L2 with positive refractive power, a third lens unit L3 with negative refractive power, and a fourth lens unit L4 with positive refractive power. During zooming from the wide-angle end to the telephoto end, the first lens unit L1 and the fourth lens unit L4 are fixed relative to the image plane IP. During zooming from the wide-angle end to the telephoto end, the second lens unit L2 and the third lens unit L3 move toward the object side. During focusing from infinity to a close distance, the third lens unit L3 moves toward the image side. The first lens unit L1 includes, in order from the object side, a negative meniscus lens L11 with a convex surface facing the object side, a negative meniscus-shaped aspheric lens L12 with a convex surface facing the object side, and a positive meniscus lens L13 with a convex surface facing the object side. The second lens unit L2 includes, in order from the object side, a biconvex lens L21, an aperture stop SP, a positive meniscus lens L22 with a convex surface facing the object side, a biconcave lens L23, and a biconvex lens L24. The third lens unit L3 includes a negative meniscus-shaped aspheric lens L31 with a convex surface facing the image side. The lens L31 has aspheric surfaces on both sides, with the object side surface being aspheric with positive refractive power stronger at the peripheral part than at the central part, and the image side surface being aspheric with negative refractive power stronger at the peripheral part than at the central part (i.e., an absolute value of refractive power of the negative lens is larger at a peripheral part than at a central part). The fourth lens unit L4 includes a biconcave lens L41 and a biconvex lens L42, arranged in this order from the object side.

The zoom lens L0 according to Example 4 includes a plurality of lens units that consist of, in order from the object side to the image side, a first lens unit L1 with negative refractive power, a second lens unit L2 with positive refractive power, a third lens unit L3 with negative refractive power, and a fourth lens unit L4 with positive refractive power. During zooming from the wide-angle end to the telephoto end, the first lens unit L1 and the fourth lens unit L4 are fixed relative to the image plane IP. During zooming from the wide-angle end to the telephoto end, the second lens unit L2 and the third lens unit L3 move toward the object side. During focusing from infinity to a close distance, the third lens unit L3 moves toward the image side. The first lens unit L1 includes, in order from the object side, a negative meniscus lens L11 with a convex surface facing the object side, a negative meniscus lens L12 with a convex surface facing the object side, a positive meniscus lens L13 with a convex surface facing the object side, and a negative meniscus lens L14 with a convex surface facing the image side. The second lens unit L2 includes, in order from the object side, a positive meniscus lens L21 with a convex surface facing the image side, an aperture stop SP, a biconvex lens L22, a negative meniscus lens L23 with a concave surface facing the object side, a negative meniscus lens L24 with a concave surface facing the image side, and a biconvex lens L25. The lenses L22 and L23 form a cemented lens. The lenses L24 and L25 form a cemented lens. The third lens unit L3 includes, in order from the object side, a biconcave lens L31 and a negative meniscus-shaped aspheric lens L32 with a concave surface facing the object side. The lens L32 has aspheric surfaces on both sides, with the object side surface being aspheric with positive refractive power stronger at the peripheral part than at the central part, and the image side surface being aspheric with negative refractive power stronger at the peripheral part than at the central part (i.e., an absolute value of refractive power of the negative lens is larger at a peripheral part than at a central part). The fourth lens unit L4 includes a positive meniscus lens L41 with a convex surface facing the image side.

The zoom lens L0 according to Example 5 includes a plurality of lens units, that consist of, in order from the object side to the image side, a first lens unit L1 with negative refractive power, a second lens unit L2 with positive refractive power, a third lens unit L3 with negative refractive power, and a fourth lens unit L4 with positive refractive power. During zooming from the wide-angle end to the telephoto end, the first lens unit L1 and the fourth lens unit L4 are fixed relative to the image plane IP. During zooming from the wide-angle end to the telephoto end, the second lens unit L2 and the third lens unit L3 move toward the object side. During focusing from infinity to a close distance, the third lens unit L3 moves toward the image side. The first lens unit L1 includes, in order from the object side, a negative meniscus lens L11 with a convex surface facing the object side, a biconcave lens L12, and a positive meniscus lens L13 with a convex surface facing the object side. The second lens unit L2 includes, in order from the object side, a biconvex lens L21, a biconvex lens L22, a biconcave lens L23, an aperture stop SP, a negative meniscus lens L24 with a concave surface facing the image side, and a biconvex lens L25. The lenses L22 and L23 form a cemented lens. The lenses L24 and L25 form a cemented lens. The third lens unit L3 includes, in order from the object side, a negative meniscus lens L31 with a convex surface facing the object side, and a negative meniscus-shaped aspheric lens L32 with a convex surface facing the image side. The lens L32 has aspheric surfaces on both sides, with the object side surface being aspheric with negative refractive power stronger at the peripheral part than at the central part, and the image side surface being aspheric with positive refractive power stronger at the peripheral part than at the central part (i.e., an absolute value of refractive power of the negative lens is larger at a peripheral part than at a central part). The fourth lens unit L4 includes a positive meniscus lens L41 with a convex surface facing the image side.

In the zoom lenses L0 according to Examples 1 to 5, all surfaces having refractive power include refractive surfaces. In comparison with a case where the surfaces having refractive power include diffractive optical elements or reflective surfaces, each example can easily achieve equivalent or better optical performance with a lower manufacturing difficulty.

The zoom lenses L0 according to Examples 1 to 5 have no optical element such as a prism that bends the optical path. The prism or the like that bends the optical path increases the thickness of the optical system, and the size reduction becomes difficult.

Next follows numerical examples 1 to 5 corresponding to Examples 1 to 5, respectively.

In surface data of each numerical example, r represents a radius of curvature of each optical surface, and d (mm) represents an on-axis distance (distance on the optical axis) between m-th and (m+1)-th surfaces, where m is a surface number counted from the light incident side. nd represents a refractive index of each optical member for the d-line, and νd represents the Abbe number based on the d-line of the optical member. The Abbe number νd based on the d-line of a certain material is expressed as:

$$v d = ( N d - 1 ) / ( NF - N C )$$

where Nd, NF, and NC are refractive indices for the d-line (587.6 nm), F-line (486.1 nm), and C-line (656.3 nm) in the Fraunhofer lines.

In each numerical example, all of d, focal length (mm), F-number, and half angle of view (°) are values when the zoom lens L0 according to each example is in an in-focus state on an object at infinity. Back focus BF represents a distance on the optical axis from the final lens surface (the surface closest to the image plane) of the zoom lens L0 to the paraxial image plane expressed as an air-equivalent length. The overall lens length of the zoom lens L0 is a distance on the optical axis from the first lens surface (the lens surface closest to the object) to the final lens surface plus the back focus. The lens unit may include one or more lenses.

In a case where the optical surface is aspheric, an asterisk * is added to the right of the surface number. The aspheric shape is expressed as follows:

$$x = ( {h}^{2} / R ) / [ 1 + {\{ 1 - ( 1 + k ) {( h / R )}^{2} \}}^{1 / 2} ] + A 4 \times {h}^{4} + A 6 \times {h}^{6} + A 8 \times {h}^{8} + A 10 \times {h}^{10} + A 12 \times {h}^{12}$$

where X is a displacement amount from a surface vertex in the optical axis direction, h is a height from the optical axis in a direction orthogonal to the optical axis, R is a paraxial radius of curvature, k is a conic constant, and A4, A6, A8, A10, and A12 are aspheric coefficients of each order. “e±XX” in each aspheric coefficient means “×10^{±XX}.” WIDE, MIDDLE, and TELE represent a wide-angle end, an intermediate zoom position, and a telephoto end.

### Numerical Example 1

UNIT: mm

SURFACE DATA

| Surface No. | r | d | nd | νd |
|---|---|---|---|---|
| 1 | 114.124 | 1.00 | 1.77250 | 49.6 |
| 2 | 12.042 | 4.29 | | |
| 3* | 43.105 | 2.50 | 1.53110 | 55.9 |
| 4* | 20.966 | 1.99 | | |
| 5 | 35.204 | 2.90 | 1.77047 | 29.7 |
| 6 | −114.527 | 1.97 | | |
| 7 | −32.492 | 1.00 | 1.49700 | 81.5 |
| 8 | −70.456 | (Variable) | | |
| 9 | 18.171 | 1.94 | 1.77250 | 49.6 |
| 10 | −529.066 | 2.48 | | |
| 11 (SP) | ∞ | 1.38 | | |
| 12 | 12.421 | 1.79 | 1.59282 | 68.6 |
| 13 | 44.069 | 0.36 | | |
| 14 | −46.037 | 1.00 | 1.68893 | 31.1 |
| 15 | 10.684 | 0.48 | | |
| 16 | 25.111 | 3.36 | 1.59282 | 68.6 |
| 17 | −21.982 | (Variable) | | |
| 18* | −18.435 | 2.00 | 1.53110 | 55.9 |
| 19* | −32.813 | (Variable) | | |
| 20 | −120.000 | 4.59 | 1.63854 | 55.4 |
| 21 | −29.908 | (Variable) | | |
| Image Plane | ∞ | | | |

ASPHERIC DATA

3rd Surface
K = 0.00000e+00 A 4 = −8.94309e−05 A 6 = 7.11824e−07
A 8 = −3.52027e−09
4th Surface
K = 0.00000e+00 A 4 = −1.48535e−04 A 6 = 6.59805e−07
A 8 = −5.15433e−09
18th Surface
K = 0.00000e+00 A 4 = 2.68346e−04 A 6 = 2.81044e−06
A 8 = −9.40023e−08
19th Surface
K = 0.00000e+00 A 4 = 2.67097e−04 A 6 = 1.59679e−06
A 8 = −5.11740e−08

VARIOUS DATA
ZOOM RATIO 2.02

| | WIDE | MIDDLE | TELE |
|---|---|---|---|
| Focal Length | 14.40 | 20.07 | 29.10 |
| Fno | 4.10 | 5.05 | 6.40 |
| Half Angle of View (°) | 43.4 | 31.7 | 25.1 |
| Overall Lens Length | 75.06 | 75.06 | 75.06 |
| BF | 11.78 | 11.78 | 11.78 |
| d8 | 16.11 | 8.43 | 0.74 |
| d17 | 1.84 | 1.00 | 6.15 |
| d19 | 10.29 | 18.81 | 21.35 |
| d21 | 11.78 | 11.78 | 11.78 |

ZOOM LENS UNIT DATA

| lens unit | Starting Surface | Focal Length |
|---|---|---|
| 1 | 1 | −21.90 |
| 2 | 9 | 19.73 |
| 3 | 18 | −83.23 |
| 4 | 20 | 61.17 |

### Numerical Example 2

UNIT: mm

SURFACE DATA

| Surface No. | r | d | nd | νd |
|---|---|---|---|---|
| 1 | 235.833 | 1.00 | 1.77250 | 49.6 |
| 2 | 10.085 | 4.16 | | |
| 3* | −895.559 | 2.50 | 1.53110 | 55.9 |
| 4* | 44.647 | 1.74 | | |
| 5 | 64.099 | 1.78 | 2.05090 | 26.9 |
| 6 | −162.178 | (Variable) | | |
| 7 | −459.615 | 2.29 | 1.48749 | 70.2 |
| 8 | −33.943 | 4.00 | | |
| 9 | 18.560 | 3.57 | 1.69680 | 55.5 |
| 10 | −16.150 | 1.00 | 1.90043 | 37.4 |
| 11 | −62.644 | 1.84 | | |
| 12 (SP) | ∞ | 4.68 | | |
| 13 | 25.922 | 1.00 | 1.83481 | 42.7 |
| 14 | 8.456 | 4.21 | 1.49700 | 81.5 |
| 15 | −26.343 | (Variable) | | |
| 16 | −34.878 | 0.80 | 1.61772 | 49.8 |
| 17 | 139.823 | 4.14 | | |
| 18* | −9.417 | 2.00 | 1.53110 | 55.9 |
| 19* | −12.991 | (Variable) | | |
| 20 | −120.000 | 4.63 | 1.63854 | 55.4 |
| 21 | −24.348 | (Variable) | | |
| Image Plane | ∞ | | | |

ASPHERIC DATA

3rd Surface
K = 0.00000e+00 A 4 = −8.12193e−05 A 6 = 8.99724e−07
A 8 = −1.19209e−08
4th Surface
K = 0.00000e+00 A 4 = −1.28410e−04 A 6 = 3.69150e−07
A 8 = −1.09948e−08
18th Surface
K = 0.00000e+00 A 4 = 2.77887e−04 A 6 = 6.15575e−06
A 8 = −2.56537e−08
19th Surface
K = 0.00000e+00 A 4 = 2.14784e−04 A 6 = 3.85389e−06
A 8 = −2.47687e−08

VARIOUS DATA
ZOOM RATIO 2.02

| | WIDE | MIDDLE | TELE |
|---|---|---|---|
| Focal Length | 14.40 | 20.23 | 29.10 |
| Fno | 4.10 | 5.04 | 6.40 |
| Half Angle of View (°) | 43.3 | 31.8 | 25.1 |
| Overall Lens Length | 78.52 | 78.52 | 78.52 |
| BF | 11.50 | 11.50 | 11.50 |
| d6 | 16.23 | 8.82 | 1.41 |
| d15 | 1.45 | 2.48 | 6.02 |
| d19 | 3.98 | 10.37 | 14.24 |
| d21 | 11.50 | 11.50 | 11.50 |

ZOOM LENS UNIT DATA

| lens unit | Starting Surface | Focal Length |
|---|---|---|
| 1 | 1 | −18.40 |
| 2 | 7 | 18.55 |
| 3 | 16 | −28.78 |
| 4 | 20 | 46.95 |

### Numerical Example 3

UNIT: mm

SURFACE DATA

| Surface No. | r | d | nd | νd |
|---|---|---|---|---|
| 1 | 121.561 | 1.00 | 1.77250 | 49.6 |
| 2 | 11.453 | 4.23 | | |
| 3* | 32.011 | 2.50 | 1.53110 | 55.9 |
| 4* | 17.762 | 2.60 | | |
| 5 | 35.611 | 3.92 | 1.84666 | 23.8 |
| 6 | 295.075 | (Variable) | | |
| 7 | 21.604 | 5.36 | 1.77250 | 49.6 |
| 8 | −124.853 | 2.01 | | |
| 9 (SP) | ∞ | 1.38 | | |
| 10 | 12.132 | 1.83 | 1.60311 | 60.6 |
| 11 | 44.069 | 0.37 | | |
| 12 | −41.117 | 1.00 | 1.69895 | 30.1 |
| 13 | 11.231 | 0.53 | | |
| 14 | 23.494 | 3.51 | 1.59282 | 68.6 |
| 15 | −19.891 | (Variable) | | |
| 16* | −28.509 | 2.00 | 1.58313 | 59.4 |
| 17* | −97.030 | (Variable) | | |
| 18 | −2406.291 | 1.00 | 1.61800 | 63.4 |
| 19 | 51.440 | 5.98 | | |
| 20 | 56.259 | 6.10 | 1.63854 | 55.4 |
| 21 | −42.231 | (Variable) | | |
| Image Plane | ∞ | | | |

ASPHERIC DATA

3rd Surface
K = 0.00000e+00 A 4 = −1.30355e−04 A 6 = 8.21595e−07
A 8 = −4.36076e−09
4th Surface
K = 0.00000e+00 A 4 = −2.09893e−04 A 6 = 7.93554e−07
A 8 = −6.47934e−09
16th Surface
K = 0.00000e+00 A 4 = 2.01749e−04 A 6 = 1.42226e−06
A 8 = −3.81941e−08
17th Surface
K = 0.00000e+00 A 4 = 2.13559e−04 A 6 = 9.56327e−07
A 8 = −2.86682e−08

VARIOUS DATA
ZOOM RATIO 2.02

| | WIDE | MIDDLE | TELE |
|---|---|---|---|
| Focal Length | 14.40 | 20.11 | 29.10 |
| Fno | 4.10 | 5.05 | 6.40 |
| Half Angle of View (°) | 43.4 | 32.0 | 24.9 |
| Overall Lens Length | 78.52 | 78.52 | 78.52 |
| BF | 13.95 | 13.95 | 13.95 |
| d6 | 15.91 | 8.35 | 0.78 |
| d15 | 1.52 | 1.00 | 5.75 |
| d17 | 1.79 | 9.88 | 12.70 |
| d21 | 13.95 | 13.95 | 13.95 |

ZOOM LENS UNIT DATA

| lens unit | Starting Surface | Focal Length |
|---|---|---|
| 1 | 1 | −20.90 |
| 2 | 7 | 19.44 |
| 3 | 16 | −69.98 |
| 4 | 18 | 61.92 |

### Numerical Example 4

UNIT: mm

SURFACE DATA

| Surface No. | r | d | nd | νd |
|---|---|---|---|---|
| 1 | 28.261 | 1.00 | 1.83481 | 42.7 |
| 2 | 13.074 | 5.81 | | |
| 3 | 276.885 | 1.00 | 1.59282 | 68.6 |
| 4 | 15.738 | 2.68 | | |
| 5 | 19.172 | 2.44 | 1.85478 | 24.8 |
| 6 | 36.771 | 2.82 | | |
| 7 | −48.200 | 1.00 | 1.49700 | 81.5 |
| 8 | −108.437 | (Variable) | | |
| 9 | −1511.954 | 2.69 | 1.48749 | 70.2 |
| 10 | −29.176 | 2.50 | | |
| 11 (SP) | ∞ | 0.50 | | |
| 12 | 20.250 | 3.66 | 1.83481 | 42.7 |
| 13 | −13.782 | 1.49 | 1.90366 | 31.3 |
| 14 | ∞ | 5.09 | | |
| 15 | 26.812 | 0.90 | 1.80400 | 46.5 |
| 16 | 8.906 | 4.06 | 1.49700 | 81.5 |
| 17 | −23.801 | (Variable) | | |
| 18 | −23.372 | 0.80 | 1.60342 | 38.0 |
| 19 | 136.314 | 2.08 | | |
| 20* | −13.181 | 2.00 | 1.53110 | 55.9 |
| 21* | −18.384 | (Variable) | | |
| 22 | −120.000 | 4.52 | 1.83481 | 42.7 |
| 23 | −27.562 | (Variable) | | |
| Image Plane | ∞ | | | |

ASPHERIC DATA
20th Surface
K = 0.00000e+00 A 4 = 3.85197e−04 A 6 = 2.12676e−06
A 8 = −1.60190e−08
21st Surface
K = 0.00000e+00 A 4 = 3.61567e−04 A 6 = 1.65279e−06
A 8 = −1.63872e−08
VARIOUS DATA
ZOOM RATIO 2.35

| | WIDE | MIDDLE | TELE |
|---|---|---|---|
| Focal Length | 12.40 | 18.70 | 29.10 |
| Fno | 4.10 | 5.13 | 6.40 |
| Half Angle of | 47.9 | 34.5 | 25.2 |
| View (°) | | | |
| Overall Lens of | 82.67 | 82.67 | 82.67 |
| Length | | | |
| BF | 11.71 | 11.71 | 11.71 |
| d8 | 18.82 | 10.10 | 1.38 |
| d17 | 1.88 | 2.57 | 6.15 |
| d21 | 3.22 | 11.26 | 16.40 |
| d23 | 11.71 | 11.71 | 11.71 |

ZOOM LENS UNIT DATA

| lens unit | Starting Surface | Focal Length |
|---|---|---|
| 1 | 1 | −18.16 |
| 2 | 9 | 17.28 |
| 3 | 18 | −25.13 |
| 4 | 22 | 41.93 |

### Numerical Example 5

UNIT: mm

SURFACE DATA

| Surface No. | r | d | nd | νd |
|---|---|---|---|---|
| 1 | 42.299 | 1.50 | 1.75500 | 52.3 |
| 2 | 18.914 | 8.16 | | |
| 3 | −142.144 | 1.20 | 1.59282 | 68.6 |
| 4 | 30.217 | 5.54 | | |
| 5 | 33.034 | 2.03 | 1.96300 | 24.1 |
| 6 | 50.217 | (Variable) | | |
| 7 | 3588.151 | 3.04 | 1.53775 | 74.7 |
| 8 | −40.853 | 1.62 | | |
| 9 | 23.007 | 4.07 | 1.79952 | 42.2 |
| 10 | −26.519 | 1.01 | 1.95375 | 32.3 |
| 11 | 79.436 | 3.46 | | |
| 12 (SP) | ∞ | 5.69 | | |
| 13 | 28.102 | 1.00 | 1.85150 | 40.8 |
| 14 | 11.348 | 4.25 | 1.59522 | 67.7 |
| 15 | −45.381 | (Variable) | | |
| 16 | 41.052 | 0.80 | 1.51742 | 52.4 |
| 17 | 15.294 | 6.27 | | |
| 18* | −51.838 | 2.10 | 1.53110 | 55.9 |
| 19* | −1006.304 | (Variable) | | |
| 20 | −200.000 | 5.59 | 1.77250 | 49.6 |
| 21 | −45.565 | (Variable) | | |
| Image Plane | ∞ | | | |

ASPHERIC DATA

18th Surface
K = 0.00000e+00 A 4 = −2.18376e−04 A 6 = 8.06571e−07
A 8 = −7.88304e−09
19th Surface
K = 0.00000e+00 A 4 = −1.88281e−04 A 6 = 7.88400e−07
A 8 = −4.74781e−09

VARIOUS DATA
ZOOM RATIO 2.35

| | WIDE | MIDDLE | TELE |
|---|---|---|---|
| Focal Length | 20.60 | 31.11 | 48.50 |
| Fno | 4.10 | 5.20 | 5.88 |
| Half Angle of View (°) | 46.4 | 33.2 | 24.2 |
| Overall Lens Length | 106.52 | 106.52 | 106.52 |
| BF | 19.41 | 19.41 | 19.41 |
| d6 | 26.05 | 13.88 | 1.70 |
| d15 | 1.00 | 2.05 | 6.67 |
| d19 | 2.72 | 13.84 | 21.40 |
| d21 | 19.41 | 19.41 | 19.41 |

ZOOM LENS UNIT DATA

| lens unit | Starting Surface | Focal Length |
|---|---|---|
| 1 | 1 | −28.51 |
| 2 | 7 | 23.49 |
| 3 | 16 | −31.34 |
| 4 | 20 | 75.20 |

Table 1 summarizes values corresponding to inequalities (1) to (4) in numerical examples 1 to 5.

TABLE 1

| | Example | | | | |
|---|---|---|---|---|---|
| | 1 | 2 | 3 | 4 | 5 |
| Inequality (1) | 1.110 | 0.992 | 1.075 | 1.051 | 1.214 |
| Inequality (2) | 0.237 | 0.645 | 0.278 | 0.688 | 0.750 |
| Inequality (3) | 1.067 | 1.030 | 1.051 | 1.406 | 1.182 |
| Inequality (4) | 0.640 | 0.674 | 0.655 | 1.020 | 0.846 |

### Image Pickup Apparatus

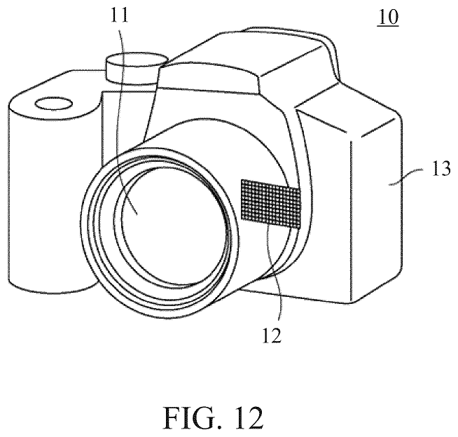

Referring now to FIG. 12, a description will be given of an embodiment of the image pickup apparatus using the zoom lens L0 according to any one of the above examples as an imaging optical system. FIG. 12 illustrates the configuration of the image pickup apparatus 10. The image pickup apparatus 10 includes a camera body 13, a lens apparatus (optical apparatus) 11 including the zoom lens L0 according to any one of Examples 1 to 5, and an image sensor (light receiving element) 12 configured to photoelectrically convert an image formed by the zoom lens L0. The image sensor 12 can be an image sensor such as a CCD sensor or a CMOS sensor. The lens apparatus 11 and the camera body 13 may be integrated with each other or attachable to and detachable from each other. The camera body 13 may be a so-called single-lens reflex camera having a quick-turn mirror, or may be a so-called mirrorless camera not having a quick-turn mirror. The image pickup apparatus 10 according to this embodiment has a reduced size and weight, and can achieve high optical performance.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide an optical apparatus that can properly control a drive unit configured to move a lens unit included in an optical system.

What is claimed is:

1. An optical apparatus comprising:
an optical system consisting of, in order from an object side to an image side, a first lens unit with negative refractive power, a second lens unit with positive refractive power, a third lens unit with negative refractive power, and a fourth lens unit with positive refractive power;
a first drive unit configured to move the second lens unit;
a second drive unit configured to move the third lens unit;
a first acquiring unit configured to acquire one of information on drive of the first drive unit and information on a position of the second lens unit; and
a processor that, upon execution of instructions, is configured to control the first drive unit and the second drive unit,
wherein the first lens unit and the fourth lens unit are fixed relative to an image plane during zooming and focusing, the second lens unit moves toward the object side during zooming from a wide-angle end to a telephoto end, and the third lens unit moves toward the image side during focusing from infinity to a close distance, and
wherein when the control unit controls the first drive unit by feedback control using the information from the first acquiring unit during zooming, the control unit controls the second drive unit by open loop control.

2. The optical apparatus according to claim 1, wherein the third lens unit moves toward the object side during zooming from the wide-angle end to the telephoto end.

3. The optical apparatus according to claim 1, wherein a mass of the second lens unit is larger than a mass of the third lens unit.

4. The optical apparatus according to claim 1, wherein the second lens unit includes three lenses or more.

5. The optical apparatus according to claim 1, wherein the third lens unit consists of a single lens.

6. The optical apparatus according to claim 1, wherein the third lens unit consists of two lenses spaced apart from each other.

7. The optical apparatus according to claim 1, wherein the third lens unit includes a negative lens having an aspheric surface, and an absolute value of refractive power of the negative lens is larger at a peripheral part than at a central part.

8. The optical apparatus according to claim 1, wherein the first drive unit is an electromagnetic motor.

9. The optical apparatus according to claim 1, wherein the second drive unit is an electromagnetic motor.

10. The optical apparatus according to claim 1, further comprising a second acquiring unit configured to acquire one of information on drive of the second drive unit and information on a position of the third lens unit,
wherein during focusing, the processor is configured to:
control the second drive unit by feedback control using the one from the second acquiring unit in a case where one of a drive speed of the second drive unit and a change amount in the drive speed is greater than a predetermined value, and
control the second drive unit by open loop control in a case where the one of the drive speed of the second drive unit and the change amount in the drive speed is less than the predetermined value.

11. The optical apparatus according to claim 1, wherein the following inequality is satisfied:
$$0.7 < - f 1 / f 2 < 1.5$$
where f1 is a focal length of the first lens unit, and f2 is a focal length of the second lens unit.

12. The optical apparatus according to claim 1, wherein the following inequality is satisfied:
$$0.1 < - f 2 / f 3 < 0.9$$
where f2 is a focal length of the second lens unit, and f3 is a focal length of the third lens unit.

13. The optical apparatus according to claim 1, wherein the following inequality is satisfied:
$$0.5 < M 2 / fw < 2.0$$
where M2 is a moving amount of the second lens unit during zooming from the wide-angle end to the telephoto end, and fw is a focal length of the optical system at the wide-angle end.

14. The optical apparatus according to claim 12, wherein the following inequality is satisfied:
$$0.4 < M 3 / fw < 1.6$$
where M3 is a moving amount of the third lens unit during zooming from the wide-angle end to the telephoto end, and fw is a focal length of the optical system at the wide-angle end.

15. The optical apparatus according to claim 1, wherein the optical apparatus is configured to be detachably mountable to a camera body.

16. The optical apparatus according to claim 15, wherein the third lens unit moves toward the object side during zooming from the wide-angle end to the telephoto end.

17. The optical apparatus according to claim 16, wherein the second lens unit includes three lenses or more.

18. The optical apparatus according to claim 17, wherein the third lens unit consists of a single lens or two lenses spaced apart from each other.

19. An image pickup apparatus comprising:
an optical apparatus according to claim 1; and
an image sensor configured to receive an image formed by the optical apparatus.
